(19) United States
(12) Patent Application Publication
(10) Pub. No.: US 2006/0008693 A1
(43) Pub. Date: Jan. 12, 2006

(54) Fuel cell

(76) Inventors: Tomoichi Kamo, Tokai (JP); Osamu Kubota, Hitachi (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/058,370

(22) Filed: Feb. 16, 2005

(30) Foreign Application Priority Data
Jul. 8, 2004 (JP) 2004-201281

(51) Int. Cl. H01M 8/04; H01M 8/10

(52) U.S. Cl. 429/34; 429/30

(57) ABSTRACT

An object of the present invention is to provide a fuel cell having a structure capable of generating a large cell output power. According to the present invention, there is provided a fuel cell including an anode for oxidizing liquid fuel, a cathode for reducing oxygen, an electrolyte membrane provided between the above described anode and the above described cathode, a fuel chamber for holding liquid fuel to be fed to the anode, an exhaust gas module having a gas-liquid separation function arranged so as to permit ventilation between the inside and the outside of the fuel chamber.

### INCORPORATION BY REFERENCE

The present application claims priority from Japanese application JP 2004-201281 filed on Jul. 8, 2004, the content of which is hereby incorporated by reference into this application.

### BACKGROUND OF THE INVENTION

The present invention relates to a fuel cell in which liquid fuel is oxidized in the anode of a membrane electrode assembly (MEA) composed of an anode, an electrolyte membrane, a cathode and a diffusion layer, and oxygen is reduced in the cathode of the same MEA.

A fuel cell is an electric power generator which is composed of at least a solid or liquid electrolyte and two electrodes (an anode and a cathode) inducing a desired electrochemical reaction, and converts the chemical energy carried by the fuel in the cell directly into electrical energy with a high efficiency.

A polymer electrolyte membrane fuel cell (PEM-FC) system is generally composed of a battery, a fuel container, a fuel feeder, and an air or oxygen feeder; in this system, the battery is formed of unit cells connected in series or in parallel according to need, and each of the unit cells is composed of a polymer electrolyte membrane, and a porous anode and a porous cathode respectively arranged on both sides of the electrolyte membrane.

Among PEM-FCs, direct methanol fuel cells (DMFCs), metal hydride fuel cells, and hydrazine fuel cells have attracted attention as small effective transportable or portable electric power supplies because these fuel cells use liquid fuel and hence the energy density per volume of the fuel is high; among these fuel cells, DMFCs using methanol as fuel can be said to be ideal electric power supply systems because methanol is expected to be produced from biomass in the near future.

For the purpose of using fuel cells such as DMFCs using liquid fuel as electric power supplies for use in portable appliances, efforts have been made to achieve high performance of electrode catalysts, high performance of electrode structure, and development of solid polymer membranes small in fuel crossover (penetration) in a manner aiming at a battery having a higher output power density. Also for the same purpose, there have been pursued ultimate technique for downsizing of fuel pumps and air blowers, and systems requiring no auxiliary driving devices such as fuel feeding pumps and air feeding blowers.

JP-A-2003-100315 (Patent Document 1) discloses a fuel cell which needs no auxiliary driving devices; in this fuel cell, a gas-liquid separation membrane is arranged on the wall of a container holding liquid fuel, for the purpose of discharging outside the container carbon dioxide (CO₂) generated in the anode, so that the generated carbon dioxide is discharged without leaking the liquid fuel outside the container.

However, now that recent advances in techniques involving MEA used in DMFCs have improved the battery performance of DMFCs, on the basis of the above disclosed cell structure with a gas-liquid separation membrane arranged therein, it comes to be difficult to bring out a large cell output power, because the above disclosed cell structure cannot discharge to a sufficient extent the carbon dioxide gas generated by the oxidation of the liquid fuel in the anode while electric power is generated in such a way that the generated carbon dioxide gas bubbles stick to the surface of the anode to impede the diffusion of the fuel.

An object of the present invention is to provide a fuel cell from which a large cell output power can be brought out.

### SUMMARY OF THE INVENTION

According to the present invention, there is provided a fuel cell composed of an anode for oxidizing liquid fuel, a cathode for reducing oxygen, an electrolyte membrane provided between the above described anode and the above described cathode, a fuel chamber to hold liquid fuel to be fed to the anode, and an exhaust gas module having a function of gas-liquid separation installed so as to permit ventilation between the inside and the outside of the fuel chamber.

Thus, there can be obtained a fuel cell in which the carbon oxide generated in the anode is discharged from the fuel chamber, and a large electric output power can be generated.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates an example of a fuel cell electric power supply system according to the present invention.

FIG. 2 illustrates an example of a fuel cell configuration of the present invention.

FIG. 3 illustrates a schematic view of a fuel cell electric power supply equipped with a cartridge holder according to the present invention.

FIG. 4 illustrates an example of a fuel chamber structure according to the present invention.

FIG. 5 illustrates an example of an exhaust gas module according to the present invention.

FIG. 6 illustrates an example of an integrated fuel chamber/exhaust gas module structure according to the present invention.

FIG. 7 illustrates an example of an anode terminal plate structure according to the present invention.

FIG. 8 illustrates an example of a cathode terminal plate structure according to the present invention.

FIG. 9 illustrates an example of an integrated current collector/cathode terminal plate structure according to the present invention.

FIGS. 10(a), 10(b) and 10(c) each illustrate an example of an anode current collector structure according to the present invention.

FIGS. 11(a), 11(b) and 11(c) each illustrate an example involving an MEA structure and diffusion layer structures according to the present invention.

FIG. 12 illustrates an example of a gasket structure according to the present invention.

FIG. 13 illustrates a schematic view of a fuel cell of an example according to the present invention.

FIG. 14 illustrates an example of a structure in which MEAs are arranged on an integrated fuel chamber/anode terminal plate structure according to the present invention.

FIG. 15 illustrates an example of a cathode terminal plate structure equipped with current collectors according to the present invention.

FIG. 16 illustrates an example of a portable information terminal structure installed with a fuel cell according to the present invention.

FIG. 17 illustrates another example of a sectional structure of a fuel chamber according to the present invention.

FIG. 18 illustrates yet another example of a sectional structure of a fuel chamber according to the present invention.

FIG. 19 illustrates an example of a sectional structure of a fuel cartridge used in a fuel cell of the present invention.

FIG. 20(A) illustrates an example of a sectional structure of the open-close mechanism of the fuel cartridge used in a fuel cell of the present invention, and an example of a sectional structure of a socket for the fuel cartridge, both views showing the conditions before mounting.

FIG. 20(B) illustrates an example of a sectional structure of the open-close mechanism of the fuel cartridge used in a fuel cell of the present invention, and an example of a sectional structure of a socket for the fuel cartridge, both views showing the conditions after mounting.

### DESCRIPTION OF REFERENCE NUMERALS

1 . . . Fuel cell; 2 . . . Fuel cartridge tank; 3 . . . Output power terminal; 4 . . . Exhaust gas opening; 5 . . . DC/DC converter; 6 . . . Controller; 11 . . . MEA with a diffusion layer; 12 . . . Fuel chamber; 13a . . . Anode terminal plate; 13c . . . Cathode terminal plate; 14 . . . Gasket; 15 . . . Screw; 16 . . . Connection terminal; 17 . . . Fuel cartridge holder; 21 . . . Rib; 22, 22a, 22b, 22c . . . Slit; 23 . . . Rib supporting plate; 24 . . . Hole; 25, 25a, 25b, 25c, 25d, 25e, 25f . . . Screw hole; 26 . . . Socket for cartridge; 27 . . . Fuel distribution groove; 28 . . . Fuel feeding pipe; 30 . . . Exhaust gas module; 31 . . . Gas-liquid separating tube; 32 . . . Module substrate; 33 . . . Gas-liquid separating membrane; 34 . . . Membrane support; 41 . . . Insulating sheet; 42, 42a, 42b, 42c . . . Current collectors; 51b, 51c . . . Interconnector; 52a, 52b, 52c . . . Fin; 60 . . . MEA; 61 . . . Electrolyte membrane; 62 . . . Electrode; 62a . . . Anode; 62c . . . Cathode; 70a . . . Anode diffusion layer; 70c . . . Cathode diffusion layer; 71a, 71c . . . Porous carbon substrate; 72 . . . Water repellent layer; 81 . . . Substrate for cathode terminal plate; 82a, 82b, 82c . . . Current collector spot facing part; 90 . . . Gasket; 91 . . . Current carrying part; 92 . . . Connection hole; 101 . . . Display device; 102 . . . Main board; 103 . . . Antenna; 104 . . . Hinge; 105 . . . Partition wall; 106 . . . Lithium ion secondary battery; 107 . . . Air filter; 108 . . . Water-absorbing quick-drying material; 111 . . . Cylinder; 112 . . . Piston; 113 . . . Venthole; 114 . . . Open-close mechanism; 115 . . . Fuel feeding pipe; 116 . . . Liquid fuel; 117 . . . High pressure gas: 121 . . . Open-close valve; 122 . . . Spring; 123 . . . Liquid passage opening; 131 . . . Socket valve; 132 . . . Seal ring.

### PREFERRED EMBODIMENTS OF THE INVENTION

Now, description will be made below on an embodiment related to the present invention, but the present invention is not limited by the embodiment to be described below.

A fuel cell 1, using methanol as fuel, to be used in the present embodiment generates electric power by directly converting the chemical energy contained in methanol into electric energy through the following electrochemical reaction. In the anode, a fed methanol aqueous solution undergoes a reaction according to formula (1) to be dissociated into carbon dioxide gas, hydrogen ions and electrons (oxidation reaction of methanol).
CH₃OH+H₂O→CO₂+6H⁺+6e⁻ (1)

The generated hydrogen ions moves in an electrolyte membrane from the anode to the cathode, and react with the oxygen gas from the air reaching the electrode by diffusion and electrons on the electrode according to formula (2) to produce water (the reduction reaction of oxygen).
6H⁺+3/2O₂+6e⁻→3H₂O (2)

Consequently, as shown by formula (3), the total chemical reaction associated with the electric power generation produces carbon dioxide gas and water by oxidizing methanol with oxygen to have the same chemical reaction formula as that in the flame combustion of methanol.
CH₃OH+3/2O₂→CO₂+3H₂O (3)

The open-circuit voltage of a unit cell is approximately 1.2 V, but the substantial voltage is 0.85 to 1.0 V owing to the effect of the penetration of the fuel into the electrolyte membrane; under practical load operation, the voltage is selected to range approximately from 0.2 to 0.6 V although no particular constraint is imposed on the voltage range. Accordingly, when unit cells are practically used as an electric power supply, the unit cells are connected in series so as to generate a predetermined voltage in conformity with the requirement from a load device. The output current density of a unit cell is affected and thereby varied by the electrode catalyst, the electrode structure and other factors; thus, a unit cell is designed so that a predetermined current may be effectively obtained by selecting the area of the electric power generation section of the unit cell. Additionally, appropriate parallel connection of unit cells makes it possible to adjust battery capacity. In the present embodiment, the rated voltage of a unit cell is set at 0.3 V.

An example of a fuel cell related to the present embodiment will be described below in detail.

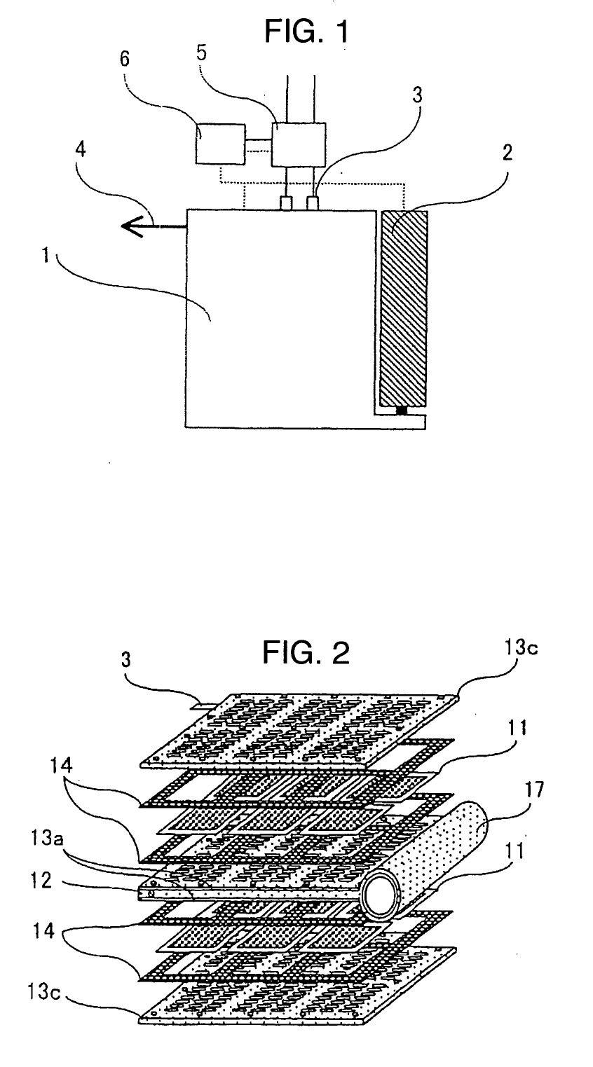

FIG. 1 shows the configuration of an electric power supply system related to the present example. The electric power supply system is composed of a fuel cell 1, a fuel cartridge tank 2, a power terminal 3 and an exhaust gas opening 4. The fuel cartridge tank adopts a fuel discharge method in which the fuel is discharged by the pressure caused by a high pressure liquefied gas, a high pressure gas or a spring; the fuel is fed from the cartridge tank to a fuel chamber 12 disclosed in FIG. 2, and the inside of the fuel chamber 12 is maintained at a pressure higher than the atmospheric pressure by the use of a liquid fuel. As electric power is generated, the fuel in the fuel chamber 12 is consumed, and the fuel is resupplied from a fuel cartridge 2. The adopted electric power supply scheme is such that the battery output power is supplied to a load device through a DC/DC converter 5, DC denoting direct current; the electric power supply system is configured such that the system includes a controller 6 set to control the DC/DC converter 5, and to output alarm signals according to need, on the basis of the acquired signals indicating the conditions of the fuel cell 1, the remaining fuel amount in the fuel cartridge tank 2, and the conditions of the DC/DC converter 5, when the electric power supply system is operated and shut down. Additionally, the controller 6 can, if necessary, indicate on the load device the operation conditions of the power supply including the battery voltage, the output current and the battery temperature; when the remaining amount in the fuel cartridge tank 2 comes to be smaller than a predetermined amount, or when the air diffusion amount deviates form a predetermined value, the electric power supply from the DC/DC converter 5 to the load device is halted, and simultaneously there is driven a malfunctional alarm such as a sound signal, a voice signal, a pilot lamp or a character display. Even when the operation is normal, the signal indicating the remaining amount in the fuel cartridge tank 2 can be received for the fuel remaining amount to be displayed on the load device.

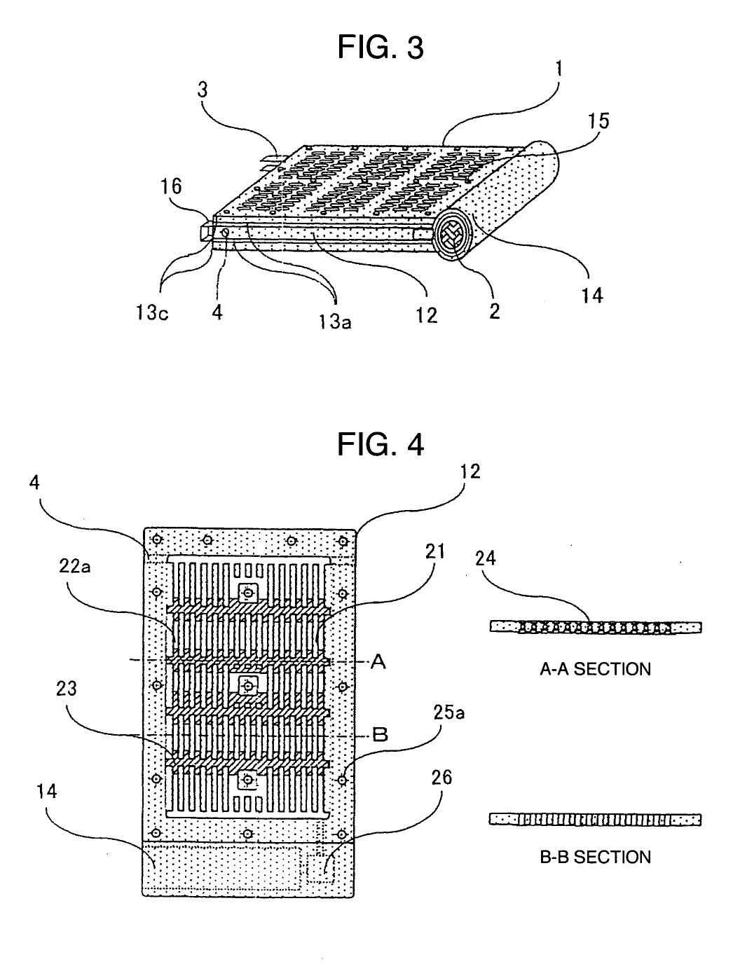

FIG. 2 shows the component configuration of a fuel cell according to an example related to the present invention. A fuel cell 1 is assembled in the following way: on each of both sides of a fuel chamber 12 equipped with a fuel cartridge holder 17, an anode terminal plate 13a, a gasket 14, an MEA with a diffusion layer 11, a gasket 14, and a cathode terminal plate 13 c are laminated in this order; the laminate thus obtained is integrally fixed with screws 15 (shown in FIG. 3) so as for the in-plane compression force to be approximately even.

FIG. 3 illustrates a schematic view of a fuel cell 1 having an electric power generation section in which six sheets of MEA with a diffusion layer are arranged on each of both sides of a fuel chamber 12 that is laminated and fixed. The fuel cell 1 has a structure in which a plurality of unit cells are connected in series on each of both sides of the fuel chamber 12, the groups of the serial unit cells on the above described two sides are further connected in series with a connection terminal 16, and the electric power is taken out from an output power terminal 3.

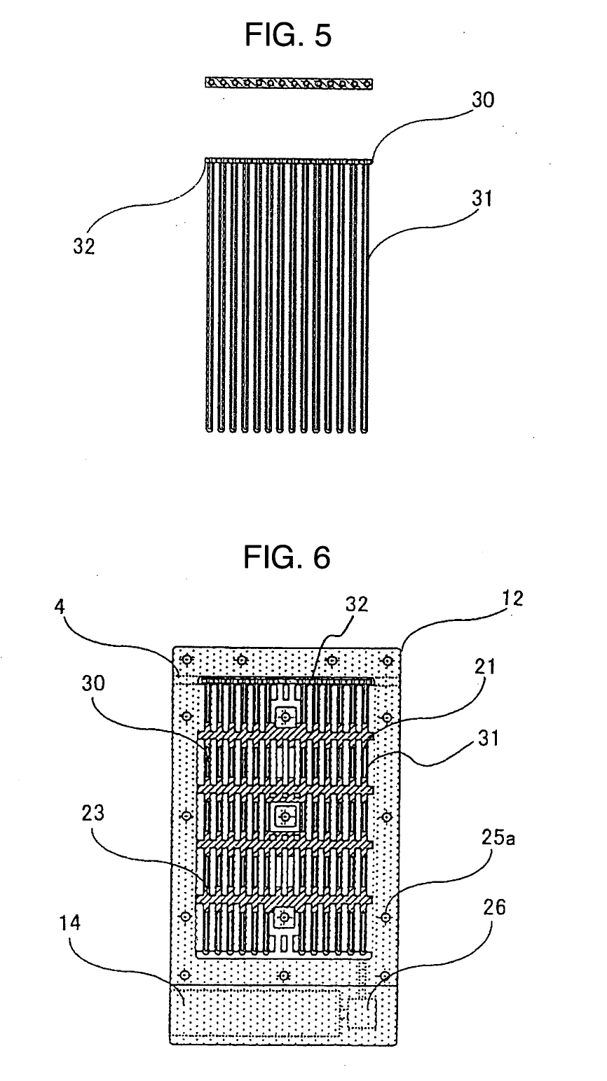

In FIG. 3, the fuel is fed from the fuel cartridge 2 under pressurized conditions provided by a high pressure liquefied gas, a high pressure gas or a spring; the carbon dioxide gas generated in the anode is discharged from an exhaust gas opening 4 through the intermediary of an exhaust gas module which is not shown in FIG. 3 but shown in FIG. 5 as an example of the present invention. The exhaust gas module has a gas-liquid separation function and an exhaust gas capture function. On the other hand, air as an oxidant is fed by diffusion from a slit 22c, the water generated in the cathode diffuses to be discharged from the slit 22c. A tightening method for integrating a battery is not limited to a method using screws 15 as disclosed in the present example; examples of the tightening method include a method in which the integration can be achieved by inserting the battery in a chassis so as for the battery to undergo compression by the compressive force exerted by the chassis.

FIG. 4 shows the structure of a fuel chamber 12 according to an example related to the present invention. The fuel chamber 12 has a plurality of ribs 21 to distribute fuel, rib supporting plates 23 supporting the ribs to form slits 22a penetrating from one side of the fuel chamber to the other side thereof; the rib supporting plates 23 are sufficiently thinner than the fuel chamber 12, and also in this portion, fuel distribution grooves are formed; and the above described supporting plates are provided with holes 24 for supporting gas-liquid separation tubes 31 disclosed in FIG. 5. Additionally, the fuel chamber 12 is provided with an exhaust gas opening 4, screw holes 25a for tightening the battery, a socket 26 for the fuel cartridge, and a fuel cartridge holder 17. The material to form the fuel chamber 12 is not particularly constrained as long as the material is such flat that even contact pressure is applied when MEAs are mounted, and the material can provide a structure in which a plurality of cells arranged on the plane of the material are insulated so as not to be short-circuited; it is recommended to use high density vinyl chloride, high density polyethylene, high density polypropylene, epoxy resin, polyetheretherketones, polyethersulfones, and polycarbonate, or glass fiber reinforced materials derived from these materials. Additionally, carbon plates, steel, nickel, alloy materials made of light weight metals such as aluminum and magnesium, intermetallic compounds represented by copper-aluminum, or various stainless steels are used for forming the fuel chamber in such a way that there can be adopt a method in which the surface of the fuel chamber is made nonconductive and a method in which the surface of the fuel chamber is made to be insulating by applying resins onto the surface.

Although the slits 22a to distribute fluids such as fuel and oxidant gas are formed as parallel grooves in FIG. 3, other configurations can also be adopted; no particular constraint is imposed on the configuration of the slits, as long as the configuration can ensure even in-plane distribution of the fluid. Although, in FIG. 3, the battery constituting components are evenly tightened with screws to achieve electric contact and sealing of liquid fuel, the tightening method is not limited to the method adopted in the present example; for example, for the purpose of obtaining a lighter and thinner power supply, effective is a method in which battery components adheres to each other with adhesive polymer film and the battery is compressed and tightened up in a chassis.

FIG. 5 shows a structure of an exhaust gas module 30 as an example according to the present invention. The exhaust gas module 30 has a structure in which a plurality of water-repellent and porous, hollow fibrous or tubular gas-liquid separation tubes 31 are connected to the module substrate 32 with the tube openings attached firmly to the module substrate 32. The outer shape of the gas-liquid separation tube 31 is selected so as to have a size permitting inserting the tube into the hole 24, shown in FIG. 4, to support the gas-liquid separation tube 31, the end of the tube not connected to the module substrate 32 being closed. The material used for the gas-liquid separation tubes is not particularly limited as long as the material is high in air permeability and strong in water repellency; there can be used hollow fiber made of porous polytetrafluoroethylene, extrusion molded tube made of polytetrafluoroethylene fibril, or tube made of woven or nonwoven cloth and subjected to water repellency treatment with a polytetrafluoroethylene dispersion liquid (D-1, manufactured by Daikin Industries, Ltd.).

FIG. 6 schematically shows a fuel chamber, as an example according to the present invention, which combines the fuel chamber 12 having a structure shown in FIG. 4 and the exhaust gas module 30 shown in FIG. 5. The respective gas-liquid separation tubes 31 in the exhaust gas module 30 are fixed so as to pass through the holes 24 bored in the rib supporting plates 23 arranged in the fuel chamber 12; the module substrate 32 is connected to the exhaust gas opening 4 of the fuel chamber, and thus has a function to discharge outside the battery the gas recovered in the respective gas-liquid separation tubes 31. Such a structure results in an arrangement in which the gas-liquid separation tubes are located with approximately the same distances from the two anodes opposed in the vicinity of the anode where carbon dioxide gas is generated; accordingly, when the fuel cartridge is mounted, the inside of the fuel chamber is in a condition where the chamber is filled with a fuel under a predetermined pressure; when no electric power is generated, no fuel leakage occurs under a pressure of a particular value or less because the water repellency of the gas-liquid separation tubes makes it impossible for the fuel to penetrate into the pores until the pressure reaches a particular value; the carbon dioxide gas, generated when the gas dissolved in the fuel is removed or the electric power generation is started, is captured in the gas-liquid separation tubes to be discharged outside the battery owing to the pressure of the liquid fuel. Accordingly, the wall thickness, the mean pore size, the pore distribution and the aperture of the used gas-liquid separation tubes are selected on the basis of the initial and final pressures of the fuel cartridge and the generation amount of the carbon dioxide gas at the maximum electric output power.

Additionally, because the respective gas-liquid separation tubes 31 in the exhaust gas module 30 are fixed so as to pass through the holes 24 in the rib supporting plates 23 arranged in the fuel chamber 12, the gas-liquid separation tubes 31 are separated from each other at an identical distance, and thus non-uniform gas discharge can be avoided.

Now, the slits 22 arranged in the anode terminal plate 13a will be described. In the case of spherical bubbles where the diameter of the detaching gas bubbles comes to be maximum, with the hole diameter D, the surface tension T, the density of the methanol aqueous solution ρ, the gravitational acceleration g, and the radius of the detaching gas bubbles γ, the following relation holds:
D=2γcos θ
where the contact angle of the gas bubble θ is determined by the following expression:
(πρgD²/24 cos²θ)(1−3 cos 2θ+sin 3θ−3 sin θ)−2πT cos²θ=0

The aperture of the slits 22 is generally selected to be 25 to 50% in view of the current collecting property and the rigidity compatible with the fixing of MEAs; additionally, in consideration of the thickness deformation of the MEAs caused by tightening and fixing, the slit width is selected to be 1 to 2 mm, the pitch of the slits is selected to be 2 to 4 mm. Consequently, with the diameter of 2 mm for the circular holes and a 10 wt % methanol aqueous solution, the contact angle of the gas bubble 0 comes to be about 60°, and the diameter 27 of the detaching gas bubbles comes to be about 4 mm. Accordingly, the separation between the gas-liquid separation module 30 and the anode terminal plate 13a facing the module is preferably set at 4 mm or less; thus, the generated and grown gas bubbles get into contact with the surface of the gas-liquid separation module 30 to be broken before the bubbles detach owing to the ascending force, and hence the gas bubbles are effectively removed, so that the gas does not block the surface of the anode, and the more stable and higher output power performance can thereby be maintained.

More specifically, the exhaust gas module 30 is not located on the wall surface of the fuel chamber as a conventional gas-liquid separation membrane formed on the wall surface of the fuel chamber, but located in the fuel chamber close to the anode surface, so that the exhaust gas module 30 makes it possible to discharge the carbon dioxide gas more efficiently.

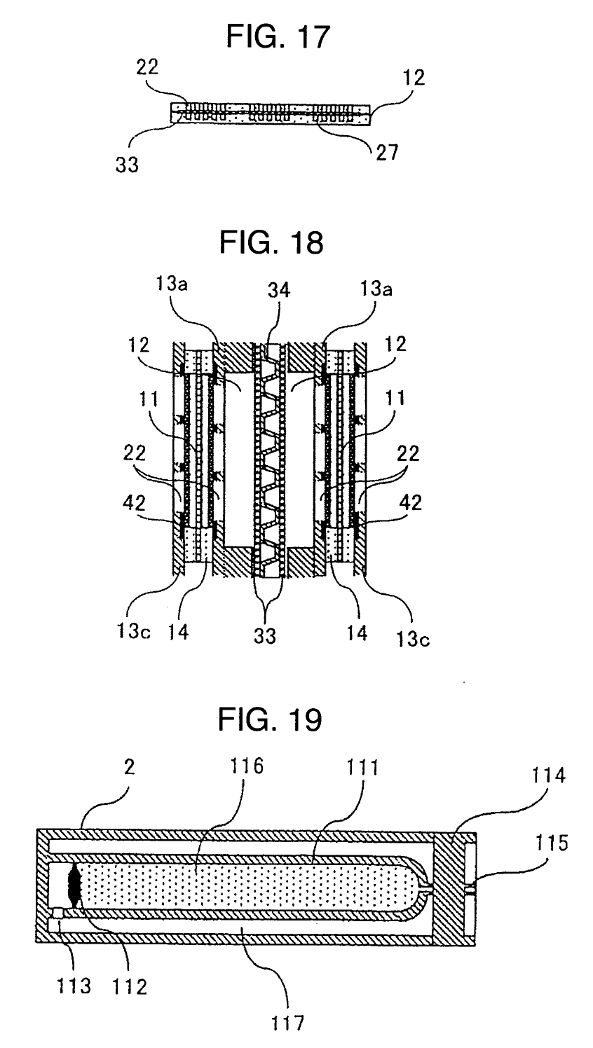

In the above case, there is shown an example in which the module is formed by using water-repellent porous hollow fibers as the gas-liquid separation tubes 31; however, the formation of the exhaust gas module is not limited to this example, but can take any shape as long as the exhaust gas module is an exhaust gas module, having a function of gas-liquid separation, arranged in the fuel chamber 12 so as to face the anode surface. For example, as shown in FIG. 17, the fuel chamber 12 is divided into a part having the slits 22 and a part having the grooves 27, and the two parts are bonded through the intermediary of a gas-liquid separation membrane 33 so as to function as an exhaust gas module. Additionally, the gas passage is not limited to the grooves, but the exhaust gas module has only to be arranged so that the exhaust gas passes through the gas-liquid separation membrane to reach the exhaust gas opening 4.

Additionally, the example disclosed in FIG. 17 is an electric power supply in which fuel cells are mounted on one side of the fuel chamber 12, whereas adoption of the sectional structure as shown in FIG. 18 makes it possible to arrange electric power generation sections on both sides of the fuel chamber 12. More specifically, gas-liquid separation membranes 33 are arranged on both sides of a membrane support 34 having air permeability and a predetermined rigidity, and the thus assembled body is installed inside the fuel chamber 12 so as to face the anode terminal plates 13a of the fuel cell.

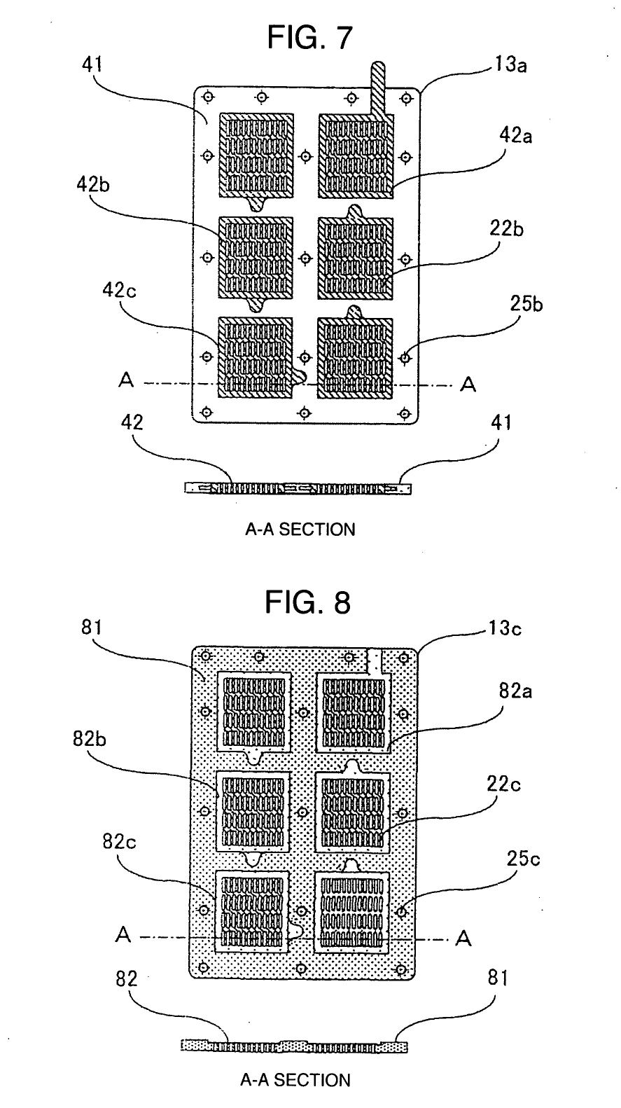

FIG. 7 shows the structure of an anode terminal plate 13a bonded to the fuel chamber. The anode terminal plate 13a has six unit cells on one side thereof, three types of electron conducting and corrosive resistant current collectors 42a, 42b and 42c are integrated with and bonded to an insulating sheet 41 for the purpose of connecting the six unit cells in series, and a plurality of slits 22b are arranged on the respective current collectors. A plurality of screw holes 25b are arranged on the insulating sheet 41 for the purpose of integrating and tightening battery components. No particular constraint is imposed on the materials to be used for the respective current collectors 42. Examples of the materials to be used include carbon plate; plates of metals such as stainless steel, titanium, and tantalum; and composite materials including clad materials, made of these metallic materials and other metals such as carbon steel, stainless steel, copper and nickel. Moreover, in the case of a metallic current collector, for the purpose of ensuring the improvement of the output power density and the long term stability of the battery, it is effective to reduce the contact resistance of the current collector in mounting by application of plating of corrosion resistant noble metals such as gold and application of a conducting carbon paint to the conducting contact portion of the fabricated current collector.

Additionally, no particular constraint is imposed on the insulating sheet 41 constituting the anode terminal plate 13a as long as the insulating sheet is a material with which the current collectors 42 arranged in the surface of the sheet can be integrated and bonded in a manner ensuring insulating property and planarity of the sheet. It is recommended to use high density vinyl chloride, high density polyethylene, high density polypropylene, epoxy resin, polyetheretherketones, polyethersulfones, polycarbonate, polyimide resin, and glass fiber reinforced materials derived from these materials. Additionally, steel, nickel, alloy materials made of light weight metals such as aluminum and magnesium, intermetallic compounds represented by copper-aluminum, and various stainless steels are used; there are applied a method in which the surface of a sheet made of these materials is made nonconductive and a method in which the surface of the sheet is made to be insulating by applying resins onto the surface; and thus, the sheet can be bonded to the current collectors 42.

The prominent feature of the present invention is that the above described anode terminal plates 13a can achieve electric contact with the current collectors 42 and MEAs without need of large rigidity of the terminal plates because the present invention adopts a method of fixing the MEAs with the ribs 21 of the fuel chamber 12, so that the anode terminal plates can be made thinner to be 0.05 to 1.0 cm in thickness. Consequently, the carbon dioxide gas, generated in the anode when electric power is generated, moves away from the electrode without growth of the gas bubbles to be large in size in the vicinity of the electrode surface, so that the bubble growth of the carbon dioxide gas on the electrode surface can be suppressed, and hence a high electric power generation performance can be maintained.

Additionally, either by chemically introducing hydrophilic groups onto the surface of the anode terminal plate 13a or by making the anode terminal plate 13a hydrophilic by dispersing to support hydrophilic substances represented by titanium oxide on the surface thereof, there is obtained a prominent effect of removing the carbon dioxide gas in the vicinity of the anode because the carbon dioxide gas generated by electric power generation does not stick to and stay on the anode terminal plate 13a, and rapidly migrates.

FIG. 8 illustrates an example of the structure of a cathode terminal plate 13c on one side of which a plurality of unit cells are arranged in series. The cathode terminal plate 13c is provided with spot facing parts 82a, 82b and 82c for bonding a plurality of current collectors 42 to a substrate 81 for cathode terminal plate, the slits 22c for diffusing oxygen as the oxidant and steam as the product to the spot facing parts 82, and moreover, screw holes 25 for integrating and tightening the fuel cell components. No particular constraint is imposed on the substrate 81 for the cathode terminal plate as long as the substrate 81 for the cathode terminal plate is a material which can bond the current collectors 42 arranged in the plane of the substrate, can ensure the insulating property and planarity, and has such a rigidity that permits in-plane tightening so that the contact resistance between the MEAs and substrate may be sufficiently small. It is recommended to use high density vinyl chloride, high density polyethylene, high density polypropylene, epoxy resin, polyetheretherketones, polyethersulfones, polycarbonate, polyimide resin, and glass fiber reinforced materials derived from these materials. Additionally, steel, nickel, alloy materials made of light weight metals such as aluminum and magnesium, intermetallic compounds represented by copper-aluminum, and various stainless steels are used; there are applied a method in which the surface of the substrate made of these materials is made nonconductive and a method in which the surface of the substrate is made to be insulating by applying resins onto the surface; and thus, the substrate can be bonded to the current collectors 42.

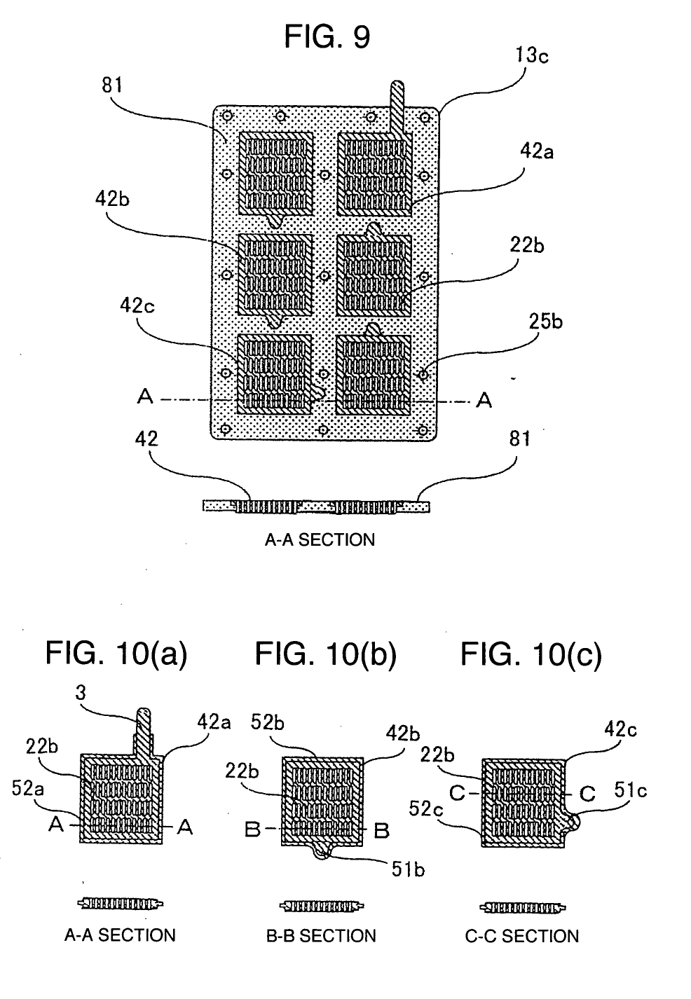

FIG. 9 schematically shows cathode terminal plate 13c in which current collectors disclosed in FIG. 10 are bonded to the spot facing parts 82 in the substrate 81 for the cathode terminal plate shown in FIG. 8. The cathode terminal plate 13c is provided with screw holes 25c for use in integrating and tightening six current collectors 42, contacting with the cathodes of six unit cells and collecting current, and fuel cell components on one side of the cathode terminal plate 13c. It is preferable that the current collectors 42 are fitted into and bonded with an adhesive to the spot facing parts 82 so as to be at the same level, as far as possible, as the flange face of the substrate 81 for the cathode terminal plate. The adhesive to be used for that purpose has only to be an adhesive which is not dissolved and not swollen in the methanol aqueous solution, and is electrochemically more stable than methanol; epoxy resin adhesives and the like are suitable. Additionally, the fixing is not limited to the fixing with adhesive; for example, fixing to a portion of each of the spot facing parts 82 can be made in such a way that on the substrate 81 for the cathode terminal plate, protrusions are formed to be fitted into a part of the slits 22b formed in the current collectors 42 or fitting holes specially formed in the current collectors 42. Additionally, the level of the current collectors 42 and the level of one side of the substrate 81 for the cathode terminal plate are not necessarily constrained to be the same; when these two levels are different to form step-like structure, for example, the current collectors 42 can be bonded to the substrate 81 for the cathode terminal plate without forming the spot facing parts 82 on the substrate 81 for the cathode terminal plate, and the structure and thickness of the gaskets to be used for sealing can be modified to meet such conditions.

FIG. 10 shows the structure of the current collectors 42 to be bonded to the anode terminal plate 13a and the cathode terminal plate 13c disclosed respectively in FIGS. 7 and 9. As for the current collectors 42, three different shapes of current collectors 42a, 42b and 42c are used for the purpose of connecting in series unit cells in one plane. The current collector 42a is provided with a cell output power terminal 3, and there are formed slits 22b for use in diffusion of fuel or air as an oxidant in the plate of the current collector 42a. The current collectors 42b and 42c are provided with interconnectors 51b and 51c for use in connecting in series unit cells in one plane, and provided with slits 22b. Moreover, when these current collectors 42 are used for the anode terminal plate 13a, there is provided a fin 52 to each of the current collectors for the purpose of integrating with and bonding to the insulating sheet 41 disclosed in FIG. 7, while when used for the cathode terminal plate 13c, the structure of the current collectors is selected so as not to have a fin 52.

The anode catalyst constituting the electric power generation section is a catalyst in which fine particles of a mixed metal of platinum and ruthenium or a platinum/ruthenium alloy are dispersed in and supported by a carbon powder carrier, and the cathode catalyst constituting the electric power generation section is a catalyst in which fine particles of platinum are dispersed in and supported by a carbon carrier; these catalyst materials are able to be easily prepared and utilized. It is generally preferable that the loading amount of platinum as the main component in relation to the carbon powder is 50 wt % or less; even when the loading amount is 30 wt % or less, a high performance electrode can be formed by using a highly active catalyst or by improving the dispersion condition on the carbon carrier. The amount of platinum in the anode 45 is preferably 0.5 to 5 mg/cm² and that in the cathode 46 is preferably 0.1 to 2 mg/cm².

However, the catalysts for the anode and cathode of the fuel cell according to the present example are not limited to particular catalyst compositions; those catalysts to be used in usual direct methanol fuel cells can be used; as the performance of a catalyst is increased, the catalyst amount can be reduced to be effective for reducing the cost of the electric power supply system.

When a proton conducting material is used for the electrolyte membrane, there can be actualized a stable fuel cell because such a cell is free from the effect of the carbon dioxide in the air. As such a material, there can be used materials of sulfonated or alkylsuofonated hydrocarbon polymers such as sulfonated fluoropolymers and polystyrene suflonic acid represented by polyperfluorostyrene sulfonic acid and perfluorocarbon sulfonic acid; and sulfonated polyethersulfones and sulfonated polyetheretherketones. When these materials are used as electrolyte membrane, fuel cells can be operated generally at a temperature of 80° C. or lower. Additionally, there can be actualized a fuel cell operatable up to higher temperatures by use of composite electrolyte membranes in which proton conducting inorganic substances such as tungsten oxide hydrate, zirconium oxide hydrate and tin oxide hydrate are microdispersed in a heat resistant resin or a sulfonated resin. In particular, composite electrolytes in which sulfonated polyethersulfones and polyetherethersulfones, or proton conducting inorganic substances are used are preferable as electrolyte membranes having a lower permeability of methanol to be used as fuel than polyperfluorocarbon sulfonic acids. In any rate, because the use of an electrolyte membrane high in proton conductivity and low in methanol permeability results in a high conversion rate of fuel into electricity, the use of such a membrane makes it possible to realize, at a high level of achievement, the effect of the present invention such that the electric supply system is made compact and long-time electric power generation is actualized.

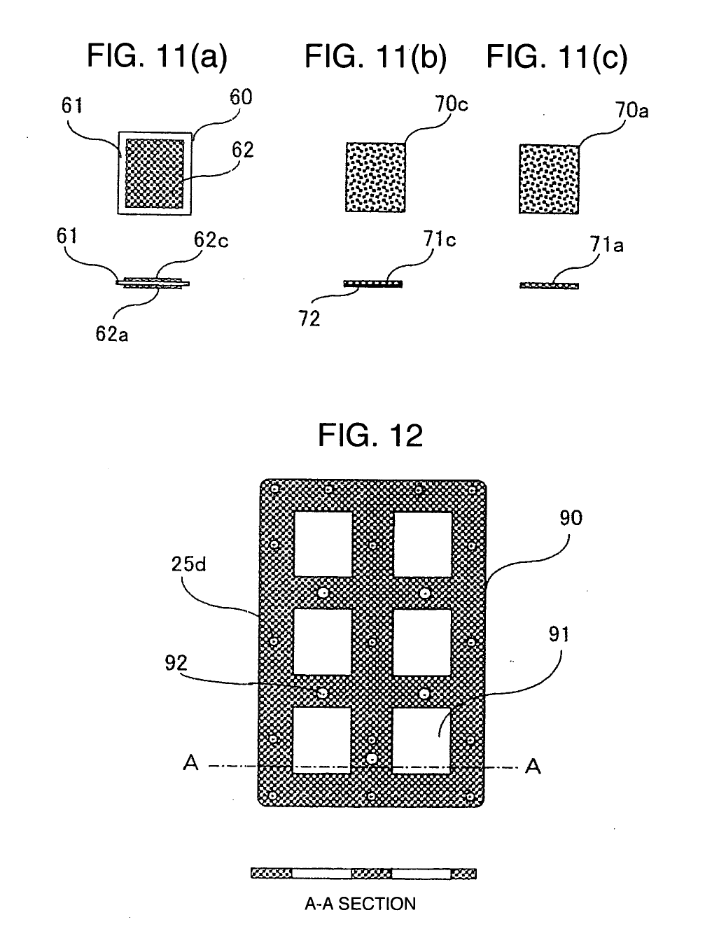

FIG. 11(a) shows the structure of an MEA 60 used in the examples of the present invention. For an electrolyte membrane 61, an alkylsulfonated polyethersuolfone is used; for an anode 62a, there is used a catalyst in which a carbon carrier (XC72R, manufactured by Cabot Co., Ltd.) supports platinum and ruthenium in an atomic ratio of 1:1 with a platinum loading amount of 30 wt %; and for a cathode 62c, there is used a catalyst in which the carbon carrier (XC72R, manufactured by Cabot Co., Ltd.) supports platinum in a loading amount of 30 wt %; for the binder, there is used an alkylsulfonated polyethersulfone which is of the same type polymer as the electrolyte membrane, but smaller in sulfonation equivalent weight than the electrolyte membrane. Such selection of the binder is characterized by making the crossover amounts of water and methanol larger in the electrolyte dispersed on the electrode catalyst than in the membrane electrolyte, so that the fuel diffusion onto the electrode catalyst is accelerated, resulting in the improvement of the electrode performance.

FIGS. 11(b) and 11(c) show the structure of a cathode diffusion layer 70c and that of an anode diffusion layer 70a used in the present invention. The cathode diffusion layer 70c is composed of a water repellent layer 72 which strengthens the water repellency, elevates the water vapor pressure in the vicinity of the cathode, and prevents the diffusive discharge of the generated water vapor and the condensation of water, and a porous carbon substrate 71c; the water repellent layer 72 is laminated so as to be in contact with a cathode electrode 62c; no particular, constraint is imposed on the surface contact between the anode diffusion layer 70a and an anode electrode 62a; and porous carbon substrate 71a is used. For the porous carbon substrate 71c of the cathode diffusion layer 70c, a conductive porous material is used. In general, there is used carbon fiber woven or nonwoven cloth such as carbon fiber woven cloth including a carbon cloth (Torayca cloth, manufactured by Toray Industries, Inc.) and a carbon paper (TGP-H-060, manufactured by Toray Industries, Inc.); the water repellent layer 72 is formed by mixing carbon powder with water repellent fine particles, water repellent fibril or water repellent fiber such as poloytetrafluoroethylene.

In more detail, a sheet of carbon paper (TGP-H-060, manufactured by Toray Industries, Inc.) is cut to a predetermined size, the absorbed amount of water of the carbon paper piece thus obtained is measured; thereafter, the carbon paper piece is immersed into a polytetrafluorocarbon/water dispersion liquid (D-1, manufactured by Daikin Kogyo Co., Ltd.) diluted so that the weight ratio after baking the carbon paper piece may be 20 to 60 wt %, and dried at 120° C. for 1 hour; and moreover, the baking operation is conducted in the air at temperatures between 270 and 360° C. for 0.5 to 1 hour. Then, to a carbon powder (XC-72R, manufactured by Cabot Co., Ltd.), the polytetrafluorocarbon/water dispersion liquid is added so as for the ratio of the liquid to be 20 to 60 wt % in relation to the carbon powder, and the mixture thus obtained is kneaded. The kneaded mixture in paste form is applied onto the one side of the carbon paper piece made water repellent as described above so as for the thickness of the kneaded mixture to be 10 to 30 μm. The carbon paper piece thus treated is dried at 120° C. for about 1 hour, and then calcined in the air at temperatures between 270 and 360° C. for 0.5 to 1 hour to yield a cathode diffusion layer 70c. The air permeability and the moisture permeability of the cathode diffusion layer 70c, namely, the diffusion properties of the fed oxygen and the generated water are largely dependent on the addition amount, the dispersibility and the baking temperature of polytetrafluoroethylene, and accordingly, these conditions for polytetrafluoroethylene are properly selected after considering the design performance and the usage environment of the fuel cell.

For the anode diffusion layer 70a, suitable materials are woven and nonwoven carbon fiber cloth to meet the required conditions involving the electric conductivity and porosity, such as carbon fiber woven cloth including a carbon cloth (Torayca cloth, manufactured by Toray Industries, Inc.) and a carbon paper (TGP-H-060, manufactured by Toray Industries, Inc.). The function of the anode diffusion layer 70a is the acceleration of the feeding of an aqueous solution fuel and the rapid dissipation of the generated carbon dioxide gas, and hence the following methods are effective for the purpose of suppressing the growth of bubbles, in the carbon porous substrate 71a, of the gas generated in the anode and increasing the output power density of the fuel cell: a method in which the surface of the above described carbon porous substrate 71a is made hydrophilic by slow oxidation or ultraviolet irradiation, a method in which a hydrophilic resin is dispersed in the carbon porous substrate 71a and a method in which a strongly hydrophilic substance represented by titanium oxide are dispersed and supported in the carbon porous substrate 71a. Additionally, the material for the anode diffusion layer 70a is not limited to the above described materials, but there can also be used porous materials such as substantially electrochemically inactive metal materials (for example, stainless steel fiber nonwoven cloth, porous bodies, porous titanium, and porous tantalum).

FIG. 12 shows the structure of a gasket 90 to be used in a fuel cell according to an example related to the present invention. The gasket 90 is constituted with cut-through current-carrying parts 91, a plurality of holes 25d for passing tightening screws therethrough, and connection holes 92 for penetrating conductors connecting the interconnectors 51 in the anode terminal plate 13a and the cathode terminal plate 13c, all these parts and holes corresponding to the plurality of MEAs to be mounted. The gasket 90 is used for sealing the fuel fed to an anode 62a and an oxidant gas fed to a cathode 62c; synthetic rubbers such as commonly used EPDM, fluorine rubbers, and silicon rubbers can be used as the materials for the gasket.

FIG. 19 shows a sectional structure of a fuel cartridge tank 2 used in the fuel cell electric power generation system according to the present invention. The fuel cartridge tank 2 has a double wall tubular structure, liquid fuel 116 is charged inside a cylinder 111 equipped with a piston 112 for pressurized extrusion and a venthole 113; and a high pressure gas 117 for driving the piston 112 for use in feeding the liquid fuel is charged between the outer cylinder and the cylinder 111.

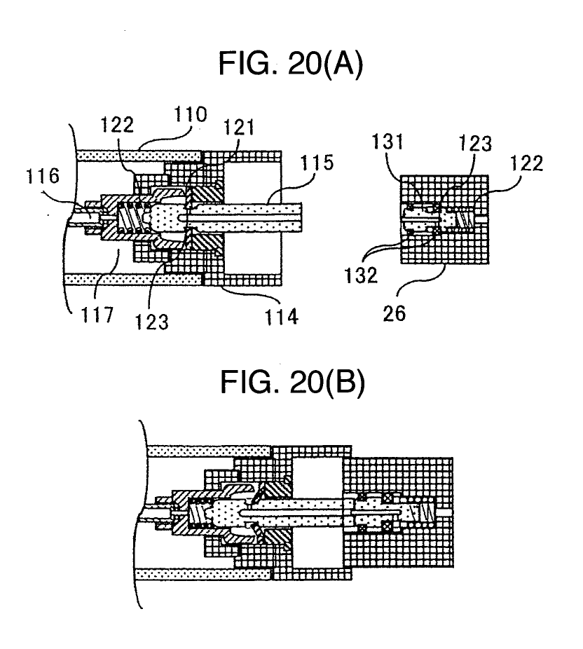

A fuel feeding pipe 115 is arranged at the tip of the cylinder 111 through the intermediary of an open-close mechanism 114. FIGS. 20(A) and 20(B) show the conditions, respectively before and after mounting, of the sectional structures of the open-close mechanism 114 and the socket 26 for the cartridge, used in the fuel cartridge tank 2. The cartridge open-close mechanism 114 is constituted with the hollow fuel feeding pipe 115 having a liquid passage opening 123, an open-close valve 121, and a spring 122 to be used for pushing the fuel feeding pipe 115 for the purpose of closing the liquid passage opening 123 by use of the open-close valve 121 when the system is shut down. On the other hand, the socket 26 for the cartridge is fixed with the spring 122 so that a socket valve 131 having the liquid passage opening 123 may close the liquid passage opening 123 with seal rings 132 when the operation of the system is shut down. When the fuel cartridge tank 2 is fixed to the socket 26 for cartridge, the respective valves are opened as shown in FIG. 20(B) and the liquid fuel 116 is transferred to the fuel cell through the socket 26 for cartridge because a high pressure gas 117 in the fuel cartridge tank 2 pushes the piston 112.

As long as the materials used for the liquid fuel cartridge 110, the open-close mechanism 114, the cylinder 111 and the socket 26 for cartridge are durable against the liquid fuel, no particular constraint is imposed on the materials; the materials are selected to be used from high density vinyl chloride, high density polyethylene, high density polypropylene, epoxy resin, polyetheretherketones, polyethersulfones, polycarbonate, polyimide resin and ethylene-propylene rubber and the like, in conformity with the compositions related to rigidity and flexibility required for the respective components. As the high pressure gas charged in the cartridge, one or more are selected to be used from the group consisting of pressurized gases such as carbon dioxide, nitrogen, argon and air, and pressurized liquefied gases such as butane and chlorofluorocarbon. Additionally, the charging pressure of the high pressure gas is varied depending on the volume ratio between the volume of the cylinder 111 and the volume of the high pressure gas charging part and the sliding resistance exerted to the piston 112 for use in feeding the liquid fuel; as the charging pressure of the high pressure gas is increased, the cylinder can be easily driven.

However, in consideration of the pressure proof property of the sealing in the fuel cell and the safety in handling the cartridge, the initial pressure is preferably 0.3 MPa or less (gauge pressure). Here is disclosed a method in which a high pressure gas is used as the force to transport the liquid fuel from the fuel cartridge to the fuel cell; however, no constraint is imposed on the method for transporting the liquid fuel, a method in which the piston is driven by use of force exerted by a spring is also effective.

### EXAMPLE 1

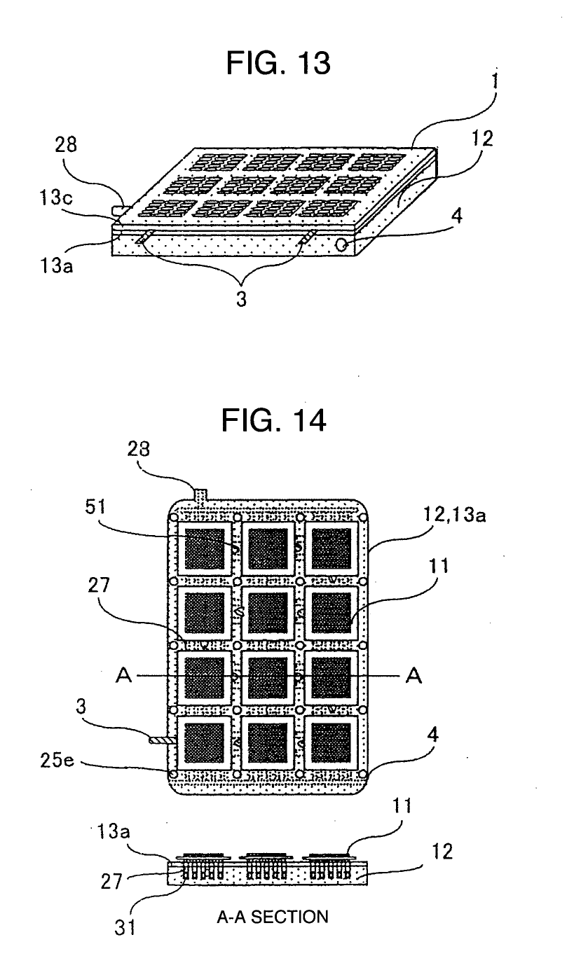

A specific example of a DMFC for use in a portable information terminal will be described below. FIG. 13 shows a schematic view of the DMFC according to the present example. The fuel cell 1 includes a fuel chamber 12, MEAs using sulfomethylated polyethersulfone as the electrolyte membrane, not shown in the figure, and a cathode terminal plate 13c and an anode terminal plate 13a sandwiching a gasket therebetween; the electric power generation section in which 12 MEAs are arranged is mounted only on one side of the fuel chamber 12. On the periphery of the fuel chamber 12, a fuel feeding pipe 28 and an exhaust gas opening 4 are arranged. Additionally, a pair of output power terminals 3 are arranged on the periphery of the anode terminal plate 13a and the cathode terminal plate 13c. The assembled structure of the cell is the same as the component configuration illustrated in FIG. 2 except that the electric power generation section is mounted only on one side of the fuel camber 12 and the fuel cartridge holder is not integrated. The materials used are high density vinyl chloride resin for the fuel chamber 12, a polyimide resin film for the anode terminal plate, and a glass fiber reinforced epoxy resin for the cathode terminal plate.

FIG. 14 shows the mounting layout of the MEAs and a sectional structure thereof. In this DMFC, 12 MEAs each having a size of 22 mm×24 mm and each having an electric power generation section of a size of 16 mm×18 mm are mounted on the surface slit part of the anode terminal plate 13a integrated with the fuel chamber 12. In the inside of the fuel chamber, as shown in the A-A section of FIG. 14, a gas-liquid separation module 30 composed of a combination of gas-liquid separation tubes 31 is inserted into fuel distribution grooves 27 arranged in the fuel chamber 12. The one end of the gas-liquid separation module 30 is connected to the exhaust gas opening 4. Additionally, one end of each of the fuel distribution grooves 27 is connected to a fuel injection tube 28 located on the periphery of the fuel chamber 12. Current collectors not shown in FIG. 14 are bonded to the outer surface of the anode terminal plate 13a so as for the level of the current collectors to be the same as the level of the surface of the anode terminal plate, and interconnectors 51 to connect the unit cells in series and a output power terminal 3 are provided.

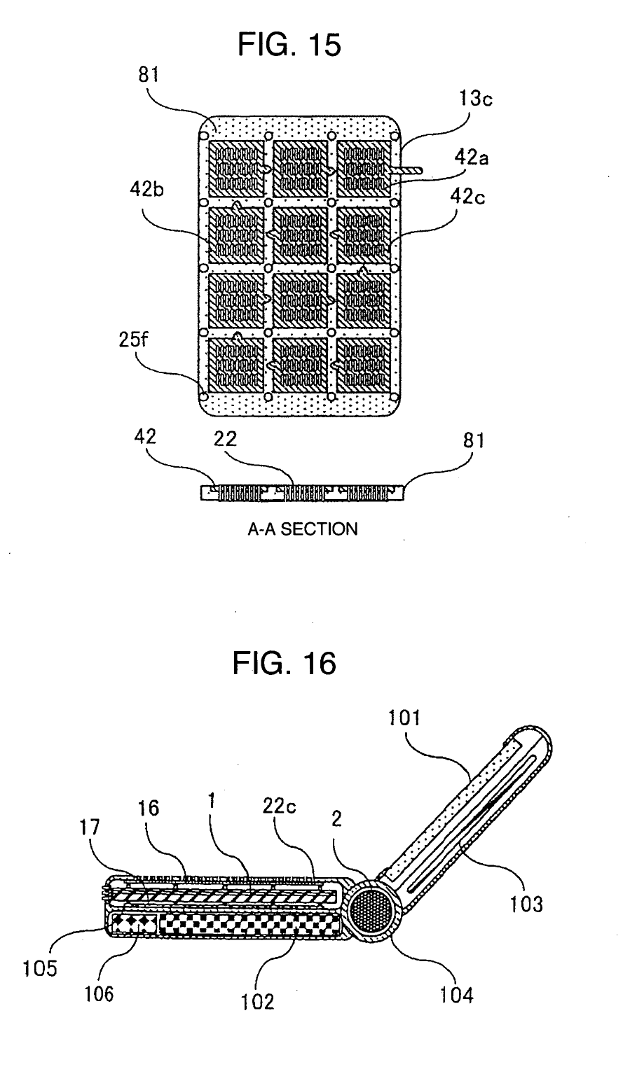

A sheet of 0.3 mm thick titanium plate was used as the material for the current collectors, and the current collector surface contacting with the electrodes was beforehand cleaned and then the surface was deposited with gold with a thickness of about 0.1 μm. FIG. 15 shows the structure of the cathode terminal plate 13c on which MEAs are fixed and the respective cells are connected in series. As for the cathode terminal plate 13c, a sheet of 2.5 mm thick glass fiber reinforced epoxy resin plate was used as the substrate 81 for the cathode terminal plate. Onto the surface of the substrate, in the same manner as described above, 0.3 mm thick gold-deposited current collectors 42a, 42b and 42c made of titanium were bonded with epoxy resin. The slits 22 for air diffusion were beforehand arranged on the substrate 81 and current collectors 40 and the slits are bonded so as to be communicatively connected with each other.

The size of the electric power supply thus fabricated is 115 mm×90 mm×9 mm. A 30 wt % methanol aqueous solution was injected into the fuel chamber 12 of the fuel cell thus fabricated, an electric power generation test was carried out at room temperature, and the resulting output power was represented by 4.2 V and 1.2 W.

The present example is a fuel cell electric power generation apparatus in which the anode to oxidize the fuel and the cathode for reducing oxygen are bonded through the intermediary of an electrolyte membrane, and liquid fuel is used, wherein in the electrically insulating fuel chamber provided with a plurality of groove structures, an exhaust gas module made of a plurality of combined water-repellent porous hollow fibers is arranged in the above described grooves so as to face the anode surface, and a plurality of fuel cells are electrically connected onto the outer surface of the fuel chamber provided with a function to discharge gas. The fuel cell electric power generation apparatus, having a structure in which a plurality of fuel cells are arranged on the outer surface of the anode chamber and are electrically connected, is suitable as an electric power supply for use in a portable appliance comparatively small in load current and requiring a high voltage as compared to the unit cell voltage of the fuel cell, and the fuel cell electric power generation apparatus can be made to be a compact electric power supply. The growth of the bubbles of the carbon dioxide gas generated by oxidation of methanol in the vicinity of the anode surface can be suppressed to increase the gas discharge ability, and the electric power generation is made possible for any orientation of the fuel cell and the ability of discharging carbon dioxide can be further enhanced by providing a function to discharge gas by use of a fluid pressure in the fuel chamber, through arranging in the groove parts of the fuel chamber the exhaust gas module provided with a plurality of combined water-repellent porous hollow fibers. Additionally, by incorporating a gas-liquid separation mechanism in the fuel chamber, the area contributing to the gas-liquid separation can be made larger, and accordingly it is possible to adopt a gas-liquid separation material with a smaller pore diameter, so that gas-liquid separation is made possible even for a higher concentration of methanol aqueous solution. Moreover, the arrangement of the exhaust gas module in the fuel chamber leads to a method to be claimed effective for preventing the liquid short circuiting caused by impurities having electrolyte character, generated between the facing electric power generation sections particularly when the electric power generation sections are arranged on both sides of the fuel chamber.

### EXAMPLE 2

As an injection-type liquid fuel cartridge 110 for feeding methanol fuel, a cartridge having a structure shown in FIG. 19 was used which was designed to have a liquid fuel volume of 10 ml, and a pressure of 0.3 MPa at an initial stage and a pressure of 0.2 MPa after use. As a material for the cartridge structure, polycarbonate was used. As a fuel, a 10 wt % methanol aqueous solution was used. The DMFC fabricated in Example 1 was used as the fuel cell, and the DMFC was combined with the above described fuel cartridge to form an electric power supply system. The electric power supply system equipped with the fuel cartridge was repeatedly operated with a period consisting of an operation at a rated load of 4.2 V and 1.2 W for 1 hour and a successive loadless stand-by for 0.5 hour. During loading period, the system was operated under a normal condition that the pressure in the inside of the fuel chamber exhibited a positive pressure of about 0.01 MPa relative to the atmospheric pressure, the system exhibiting a stable performance without liquid leakage. A cumulative operation period of 15 hours was achieved with an output power of 1.2 W.

The present example is a fuel cell electric power generation apparatus in which an anode to oxidize the fuel and a cathode for reducing oxygen are bonded to each other through the intermediary of an electrolyte membrane, and a liquid is used as fuel, wherein a fuel chamber with a plurality of groove structures is electrically insulating, to the fuel chamber is connected a fuel cartridge to extrude the liquid fuel by use of the force exerted by a liquefied high pressure gas or a high pressure gas, or the reaction force of a spring, and the liquid fuel is fed under the condition that the pressure of the fuel chamber is higher than the atmospheric pressure. The fuel cell electric power generation apparatus, having a structure in which a plurality of fuel cells are arranged on the outer surface of the anode chamber and are electrically connected, is suitable as an electric power supply for use in a portable appliance comparatively small in load current and requiring a high voltage as compared to the unit cell voltage of the fuel cell, and the fuel cell electric power generation apparatus can be a compact electric power supply.

Additionally, an exhaust gas module made of a plurality of combined water-repellent porous hollow fibers and the like is arranged in the grooves of the fuel chamber; the carbon dioxide gas, generated from the anode surface when the electric power is generated, can be discharged by use of the fluid pressure in the inside of the fuel chamber; and moreover, the carbon dioxide gas can be discharged without being accompanied by liquid fuel leakage even when the fuel cell is operated at any orientation thereof. Additionally, the adoption of the fuel resupply using a fuel cartridge makes it possible to easily carry out the fuel resupply, so that there can be actualized an electric power supply requiring no charging time in contrast to secondary batteries and most suitable for portable appliances.

When the pressure inside the fuel chamber is not made positive (larger than the atmospheric pressure), the carbon dioxide gas generated in the anode is accumulated inside the anode chamber, and is discharged into the atmosphere through the gas-liquid separation membrane when the pressure of the carbon dioxide gas reaches a predetermined value (for example, 0.05 atm) related to the gas permeation rate of the gas-liquid separation membrane. Consequently, there is created a space accumulating the carbon dioxide gas. However, the pressure inside the fuel chamber is maintained to be positive, and the liquid fuel is thereby compressed, so that the generated carbon dioxide gas is completely discharged into the atmosphere when the positive pressure of, for example, 0.05 atm is applied, and hence in principle no space for accumulating the carbon dioxide gas is needed in the anode chamber. As a result, the contact efficiency with the anode comes to be high, which is effective for making the cell compact.

### EXAMPLE 3

FIG. 16 shows an example in which the DMFC fabricated in Example 1 is mounted in a portable information terminal having a maximum output power of 3 W and an average output power of 2 W. The portable information terminal has a folding structure in which a display device 101 with a touch panel input device integrated therewith, a portion with a built-in antenna 103, a main board 102 mounted with electronic devices and electronic circuits such as a fuel cells 1, a processor, volatile and nonvolatile memories, an electric power controlling section, a hybrid controlling section of the fuel cells and a secondary battery, and a portion mounted with a lithium ion secondary battery 106 are connected with a hinge 104 doubling as a holder for a fuel cartridge 2.

A partition wall 105 divides the power supply mounting section, in such a way that the main board 102 and the lithium ion secondary battery 106 are placed in the lower section and the fuel cells 1 are arranged in the upper section. The upper wall and side wall of the chassis are provided with slits 22c for diffusion of air and cell exhaust gas. The surface of the portions of the slits 22c inside the chassis are provided with an air filter 107, and the surface of the partition wall is provided with a water-absorbing quick-drying material 108. No particular constraint is imposed on the air filter, as long as the air filter is a material high in gas diffusivity and capable of preventing the penetration of powder dust; a mesh-like material or a woven cloth made of single threads of a synthetic resin is suitable, because no clogging is caused. The present example used a single thread mesh made of polytetrafluoroethylene high in water repellency.

There is provided a fuel cell electric power generation apparatus in which the anode to oxidize the fuel and the cathode for reducing oxygen are bonded to each other through the intermediary of an electrolyte membrane, and a liquid is used as fuel, wherein a fuel chamber with a plurality of groove structures is electrically insulating, an exhaust gas module made of a plurality of combined water-repellent porous hollow fibers is arranged in the above described grooves so as to face the anode surface, and a plurality of fuel cells are electrically connected to the outer surface of the fuel chamber having a function of gas discharge. Additionally, there is included a method in which to the fuel chamber is connected a fuel cartridge to extrude the liquid fuel by use of the force exerted by a liquefied high pressure gas or a high pressure gas, or the reaction force of a spring, and the liquid fuel is fed under the condition that the pressure of the fuel chamber is higher than the atmospheric pressure.

The fuel cell electric power generation apparatus, having a structure in which a plurality of fuel cells are arranged on the outer surface of the anode chamber and are electrically connected, is suitable as an electric power supply for use in a portable appliance comparatively small in load current and requiring a high voltage as compared to the unit cell voltage of the fuel cell, and the fuel cell electric power generation apparatus can be made to be a compact electric power supply. Additionally, provision of a plurality of grooves in the fuel chamber makes it possible to omit or to make thinner an anode side end plate for use in tightening the cell; thus, the growth of the bubbles of the carbon dioxide gas generated by oxidation of methanol in the vicinity of the anode surface can be suppressed to increase the gas discharge ability. The electric power generation is made possible for any orientation of the fuel cell and the ability of discharging carbon dioxide can be further enhanced by providing a function to discharge gas by use of a fluid pressure in the fuel chamber, through arranging in the groove parts of the fuel chamber the exhaust gas module provided with a plurality of combined water-repellent porous hollow fibers.

Moreover, the use of the fuel cartridge to extrude the liquid fuel by use of the force exerted by a liquefied high pressure gas or a high pressure gas, or the reaction force of a spring makes it possible to actualize an electric power supply requiring no driving force for feeding fuel. Additionally, by incorporating the gas-liquid separation mechanism in the fuel chamber, the area contributing to the gas-liquid separation can be made larger, and accordingly it is possible to adopt a gas-liquid separation membrane with a smaller pore diameter, so that gas-liquid separation is made possible even for a higher concentration of methanol aqueous solution.

Additionally, a liquid fuel is high in volume energy density and can be easily resupplied by use of a fuel cartridge, so that there can be actualize an electric power supply requiring no charging time in contrast to secondary batteries and most suitable for portable appliances.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell comprising an anode for oxidizing liquid fuel, a cathode for reducing oxygen, an electrolyte membrane provided between said anode and said cathode, a fuel chamber for holding liquid fuel to be fed to said anode, and an exhaust gas module having a gas-liquid separation function arranged so as to permit ventilation between the inside and the outside of said fuel chamber.

2. The fuel cell according to claim 1, wherein said exhaust gas module is formed by comprising a water-repellent material and a porous material therein.

3. The fuel cell according to claim 1, wherein said exhaust gas module is arranged so as to face at least a part of the surface of the anode.

4. The fuel cell according to claim 1, wherein the shortest distance between said exhaust gas module and the surface of the anode is 0 mm or more and 4 mm or less.

5. The fuel cell according to claim 1, wherein said exhaust gas module has a structure in which water-repellent and porous gas-liquid separation tubes are connected to the module substrate with the tube openings attached to the module substrate.

6. The fuel cell according to claim 5, wherein said gas-liquid separation tubes are fixed so as to pass through holes in a rib supporting plate arranged in the fuel chamber.

7. A fuel cell comprising an anode for oxidizing liquid fuel, a cathode for reducing oxygen, an electrolyte membrane provided between said anode and said cathode, a fuel chamber for holding liquid fuel to be fed to said anode, an exhaust gas module arranged so as to permit ventilation between the inside and the outside of said fuel chamber, wherein said exhaust gas module has holes having a function of discharging carbon dioxide gas and larger than the pores of the porous material.
